(19) United States
(12) Patent Application Publication
(10) Pub. No.: US 2007/0174529 A1
(43) Pub. Date: Jul. 26, 2007

(54) Queue manager having a multi-level arbitrator

(75) Inventors: Jose M. Rodriguez, San Jose, CA (US); Soon Chieh Lim, Gelugor (MY)

Correspondence Address: RYDER IP LAW;C/O INTELLEVATE, P. O. BOX 52050, MINNEAPOLIS, MN, 55402, US

(73) Assignee: Intel Corporation

(21) Appl. No.: 11/321,199

(22) Filed: Dec. 29, 2005

(51) Int. Cl. G06F 13/14

(52) U.S. Cl. 710/240

(57) ABSTRACT

In some embodiments an apparatus is described that includes a plurality of registers associated with a plurality of queues storing data awaiting processing. The registers track amount and location of data for the associated queues and generate a request for dequeuing the data when the associated queue has a certain amount of data associated therewith. The apparatus includes an arbitrator to arbitrate among the requests and to forward an arbitrated request for processing. Other embodiments are otherwise disclosed herein.

### BACKGROUND

Store-and-forward devices (e.g., routers, firewalls) receive data (e.g., packets), process the data and transmit the data. The processing may be simple or complex. The processing may include routing, manipulation, and computation. Network processors may be used in the store-and-forward devices to receive, process and forward the data. The data may be received from multiple external sources and be destined for multiple external sources. The data may have different priorities associated therewith. The data may be stored in queues while it is awaiting processing. The queues may be located in memory that is local to the network processor or that is contained off-chip. The memory may be dynamic read access memory (DRAM).

The queues may be organized by destination and other parameters such as priority. The network processor may include a queue manager to track amount of data for each queue and the location of the data (maintain a list of pointers for the queues). The queue manager may include a plurality of FIFOs, with a FIFO storing the location of the data for an associated queue. The queue manager may not be aware of the different priorities or destinations associated with the queues. Once the queue manager determines that one or more of the queues (based on the associated FIFOs) has a certain amount of data associated therewith, the queue manager may request the data be dequeued.

The network processor may include a central processing unit to perform one or more functions on the data. The central processing unit may also be responsible for dequeuing data from the queues. If the central processing unit determines that only a single queue is ready for dequeuing it may simply dequeue data from that queue. However, if the central processing unit determines that multiple queues are ready to dequeue data, the central processing unit may arbitrate amongst the queues. The arbitration may be a simple round robin scheme. Requiring the central processing unit to perform arbitration takes away from other processes the core processor can be performing.

### BRIEF DESCRIPTION OF THE DRAWINGS

The features and advantages of the various embodiments will become apparent from the following detailed description in which:

FIG. 1 illustrates a high-level block diagram of an example network processor, according to one embodiment;

FIG. 2 illustrates an example hardware based arbitrator for use in a queue manager; according to one embodiment;

FIG. 3 illustrates an example 64-bit arbitrator, according to one embodiment;

FIG. 4 illustrates an example hierarchical arbitrator having different priority queues handled at different levels of the hierarchy, according to one embodiment;

FIG. 5 illustrates an example network processor, according to one embodiment; and

FIG. 6 illustrates an example QM communicating with a core processor, according to one embodiment.

### DETAILED DESCRIPTION

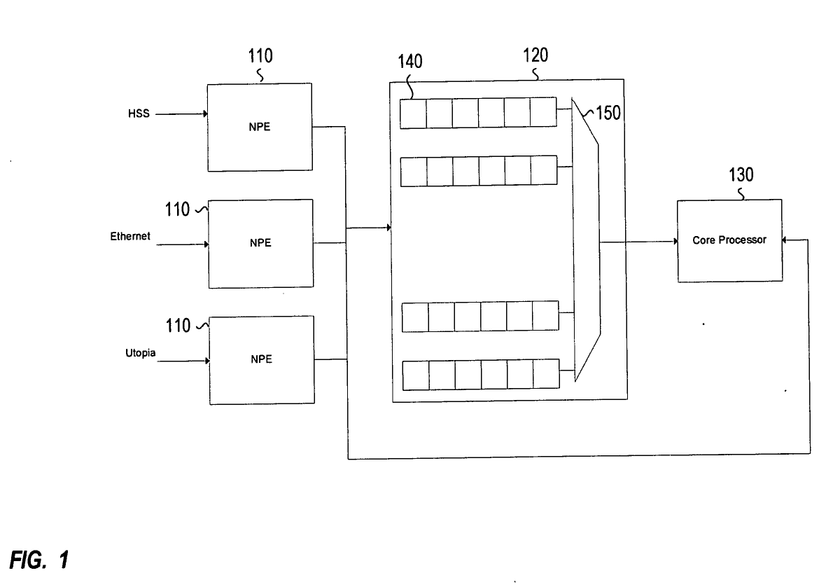

FIG. 1 illustrates a high-level block diagram of an example network processor 100. The network processor 100 includes a plurality of Network Processing Engines (NPE) 110, a Queue Manager (QM) 120, and a core processor 130. The NPEs 110 receive traffic (e.g., packets) from external sources and forward the packets to memory. The traffic received may be associated with different protocols/interfaces, such as those illustrated (Ethernet, Utopia, and High Speed Serial (HSS)). Each NPE 110 may handle a different protocol/interface. The memory may be organized as a plurality of queues, where the queues may be based on various parameters including destination, priority, quality of service (QoS), and protocol/interface. The memory (queues) may be local to the network processor 100 (on the processor die) or may be separate from the network processor (off-die memory). The memory may be dynamic read access memory (DRAM). When the NPEs 110 receive packets from the external sources they associate the packets with an appropriate queue based on various parameters and write the packets to memory.

The QM 120 may include a plurality of FIFOs 140 and associated with the plurality of queues. When the NPEs 110 write the packets to memory (queues) they also enqueue a memory pointer (identification of where the packet is stored) in an appropriate FIFO 140. When a FIFO 140 reaches a certain watermark (e.g., near-full, full) indicating that an associated queue is ready for dequeuing (has a certain amount of packets associated therewith) it may request processing from the core processor 130. The QM 120 may request processing by issuing an interrupt to the core processor 130 (a request to interrupt the core processor's current processing in order to dequeue data from an appropriate queue). The QM 120 may include a logical OR gate 150 receiving interrupts from each of the FIFOs 140 so that if any queue or multiple queues are ready for dequeuing an interrupt is generated. The QM 120 may not know any information about the underlying queues. That is, the parameters associated with the queues (e.g., destination, priority) are transparent to the QM 120, the QM 120 does not know and/or assume what the queues are used for. The QM 120 treats the queues equally, and does not perform any arbitration among the queues.

After receiving an interrupt indicating that at least one queue is ready for dequeuing, the core processor 130 may examine the FIFOs 140 (status registers) to determine which queue (or queues) is actually ready for processing. If it is determined that a single queue is ready for processing the core processor 130 may process accordingly. If it is determined that two or more queues are ready for processing, the core processor 130 may need to arbitrate between the queues. The arbitration may take into account the parameters (e.g., priority, quality of service) associated with the queues the queues.

Requiring the core processor 130 to arbitrate between queues drains core processor resources. Additionally, when a lot of queues are ready for processing (associated FIFO reaches watermark) the QM 120 may continually initiate interrupts (request processing) from the core processor 130. Hence, the core processor 130 may be very busy processing dequeue requests, which in turn limits cycle time available for network processes, which may have a higher priority (e.g., voice, data, video). Having the QM 120 provide arbitration would free resources for the core processor 130 as the core processor 130 would not need to arbitrate amongst queues.

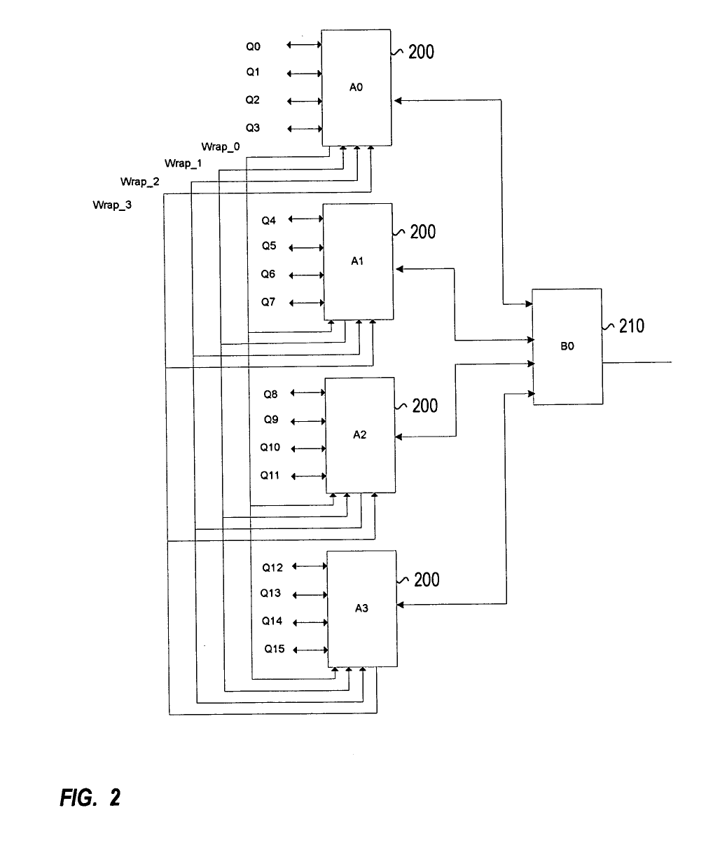

FIG. 2 illustrates an example hardware based arbitrator that can be used within a QM (e.g., 120 of FIG. 1) to perform arbitration. The arbitrator may be used to arbitrate among the interrupt requests generated by FIFOs (e.g., 140 of FIG. 1) tracking pointers for the associated queues. The arbitrator may include a 2 level hierarchy of 4×1 arbiters for arbitrating amongst requests for 16 input queues (labeled Q0-Q15). A first level may include four 4×1 arbiters 200 (labeled A0-A3) and a second level may include a 4×1 arbiter 210 (labeled B0). The first level arbiters 200 receive the requests (interrupts) from the FIFOs associated with four input queues. The request may be a single bit that is activated (e.g., set to 1) if the associated queue is requesting processing (dequeuing). The arbiter 200 may OR all of the requests in order to generate a single request to the second level arbiter 210. The second level arbiter 210 receives the single request from each of the four first level arbiters 200 and arbitrates among them and issues the appropriate first level arbiter 200 a grant. The first level arbiter 200 receiving the grant then arbitrates among the requests from the input queues and issues a grant to one of them.

The arbitration scheme implemented by the arbiters 200, 210 may be a simple round robin (RR) scheme or may be more complex, such as a weighted RR (WRR) or deficit RR (DRR). The arbitration may start at the first input (e.g., Q0, Q12, A0) and find the first input requesting processing. Depending upon the type of arbitration scheme used, the arbitration may continue from the input that received the grant or may start from the next input after the input that received the grant.

Once an arbiter 200, 210 has finished processing (has received grants) its requests it will want to receive a new allotment of requests. However, in order to maintain the arbitration scheme the arbiters 200, 210 should be reset at the same time. Since the second level arbiter 210 receives requests from the first level arbiters 200 aligning the reset of the first level arbiters 200 will also align the second level arbiter 210. Accordingly, each first level arbiter 200 may have an input control signal that is activated (e.g., set to ‘1’) when there are no remaining requests for the arbiter 200. Each first level arbiter 200 may receive the input control signal from each other first level arbiter 200 and the input control signals may be logically AND-ed to gate/lock the arbiters 200 at the current arbitration round. The first level arbiters 200 are not allowed to perform the next arbitration round until the input control signal from the other first level arbiters 200 goes high. That is, a reset of the arbitrator (arbiters 200, 210) only occurs once all of the input control signals are set (indicating that none of the arbiters 200 have requests for processing during that round of arbitration).

By way of example, assume that each of the arbiters 200, 210 utilizes a RR scheme and that queues Q0, Q2, Q5, and Q12 have requests. Accordingly, arbiters A0, A1 and A3 would have requests. As there are no requests to be processed in arbiter A2, the input control signal would according be set. Arbiter B0 would start the RR arbitration process (at the A0 input) and determine that the first request was from arbiter A0 and would issue a grant to arbiter A0. Arbiter A0 would start the RR arbitration process (at the Q0 input) and determine that the first request was from Q0 and would issue a grant to Q0. Since Q0 is not the only request being processed by arbiter A0 the input control signal would not be activated. Arbiter B0 would then proceed with the RR arbitration process (from input A1) and determine that A1 had a request and thus issue a grant. Arbiter A1 would start the RR arbitration process (at the Q4 input) and determine that the first request was from Q5 and would issue a grant to Q5. As Q5 was the only request from arbiter A1 and it has now been processed the input control signal would be activated.

Arbiter B0 would then proceed with the RR arbitration process (from input A2) and determine that A3 had a request and thus issue a grant. Arbiter A3 would start the RR arbitration process (at the Q12 input) and determine that the only request was from Q12 and would issue a grant to Q12 and would activate the input control signal. As arbiter A0 does not have the input control signal set, the arbitration round is not complete. Accordingly arbiter B0 would proceed with the RR arbitration process (return to input A0) and determine that arbiter A0 had a request and issue a grant. Arbiter A0 would determine that the next request was from Q2 and would issue a grant and then set the input control signal as Q2 was the last request. The first level arbiters 200 would then be reset to reflect new requests and the arbitration process begins again.

If the data being received by the network processor has different parameters (e.g., QoS requirements) the data may need to be processed differently. That is, data having higher QoS requirements may be given priority. In order to give certain queues priority the arbitration scheme implemented by the first level arbiters 200 and/or the second level arbiter 210 may be a WRR, DRR, or other complex schemes that enable priority processing for particular queues or groups of queues. These arbitration schemes may assign the request lines quantums (number of grants capable of being issued per arbitration round). For example, queues having a low priority may be assigned a quantum of 1, queues having an intermediate priority may have a quantum of 2, and queues having a high priority may have a quantum of 3. Accordingly, during a round of arbitration the higher priority queues may be processed (have grants issued) three times as much at the low priority queues and 1.5 times more then the medium priority queues.

If the priority queues are grouped together (e.g., the queues handled by A0 (Q0-Q3) are the high priority queues) the second level arbiter 210 may utilize the more complex arbitration scheme and apply a higher quantum to an associated request line (e.g., A0 requests). If the priority queues are scattered, the lower level arbiters 200 may utilize the more complex arbitration schemes and apply a higher quantum to associated queue requests. If groups of queues have different priorities and queues within the groups have different priorities both the first level 200 and the second level arbiters may utilize the more complex arbitration schemes and apply different quantums.

DRR may process requests up to the quantum for each request line prior to proceeding to the next request line (a pointer may remain at the current queue after a grant has been issued). Accordingly, only a single round of arbitration is performed. WRR may process a single request for each request line at a time (a pointer may move to a next queue as soon as a grant is issued). Request lines having additional quantums will be processed in subsequent rounds. Assume that a first queue had a quantum of 3, a second queue had a quantum of 2, and a third queue had a quantum of 1. DRR may issue 3 grants to the first queue, then two grants to the second queue, then one grant to the third queue (Q1, Q1, Q1, Q2, Q2, Q3). WRR may issue a grant to the first queue, the second queue and the third queue in a first round, then may issue a grant to the first queue and the second queue in a second round, and then may issue a grant to the first queue in a third round (Q1, Q2, Q3, Q1, Q2, Q1).

The arbiters 200, 210 may be capable of having quantums assigned for each of the request lines. For example, each request line may have a register that can record the quantum. The arbiters 200, 210 may be capable of enabling or disabling complex arbitration. For example, the arbiters may have a complex arbitration bit that is activated (e.g., set to 1) if the arbiters are to utilize the quantums for complex arbitration. The arbiters 200, 210 may decrement the quantum each time a grant is issued. When the quantum equals zero no more grants will be issued for that round of arbitration. The quantum is reset when the next round of arbitration begins.

Referring back to FIG. 2, assume that arbiters 200, 210 are DRR arbiters and that the first level arbiters 200 have DRR mode set and that the second level arbiter 210 does not have DRR mode set (will perform simple RR). For simplicity, let's assume only Q1, Q5, Q6, Q9 have reached their watermark and accordingly have issued requests for attention from the core processor. Accordingly, arbiters A0, A1 and A2 will send requests to arbiter B0. Assume that Q1 and Q5 have a quantum of 2 (deficit count will be set at 2), while Q6 and Q9 have a quantum of 1 (deficit count set to 1). Since A3 does not have any requests the A3 input control signal will be activated indicating that it does not have any remaining requests this round.

During a first arbitration cycle (T0), B0 issues a grant to A0 (first request in B0), and A0 issues the grant to Q1 (only request in A0). Q1's deficit counter is decremented from 2 to 1. During a second arbitration cycle (T1), B0 issues a grant to A1 (next request in B0), and A1 issues a grant to Q5 (first request in A1). Q5's deficit counter decrements from 2 to 1. During a third arbitration cycle (T2), B0 issues a grant to A2, and A2 issues the grant to Q9 (only request in A2). Q9's deficit counter decrements from 1 to 0. There are no more requests in A2 so the A2 input control signal will be activated indicating that it does not have any remaining requests this round. During T3, B0 issues a grant to A0 (A3's input control signal set so it was skipped), and A0 issues the grant to Q1 (first request since Q1s deficit count was not zero and the pointer remained there). Q1's deficit counter decrements from 1 to 0. There are no more requests in A0 so the A0 input control signal is activated indicating that it does not have any remaining requests this round. During T4, B0 issues a grant to A1, and A1 issues the grant to Q5 as Q5s deficit counter is 1. Q5's deficit counter decrements from 1 to 0.

During T5, B1 issues a grant to A1 again because it is the only arbiter whose input control signal is not set (the other arbiters input control signals are set indicating that they do not have any more requests to process). A1 issues the grant Q6 (next request), the Q6 deficit count is decremented from 1 to 0, and the A1 input control signal is set. During T6, all the level 1 arbiters' 200 have their input control signals set so the arbiters will be reset and will wrap back to the first state and the whole process repeats again. The complete round of arbitration issued grants in the following order Q1, Q5, Q9, Q1, Q5 and Q6. That is Q1 and Q5 were granted twice, while Q6 and Q9 were only granted once which corresponds to the assigned quantums. Hence, by changing the quanta, we can allocate more bandwidth to high priority queues.

The 4-to-1 arbiter building block architecture illustrated in FIG. 2 enables a silicon engineer to create huge arbiters with logic delays proportional to log₄(N), where N=number of input queues. As illustrated in FIG. 2, 16 queues were utilized so that the logic delay (number of levels) to determine a next queue is equal to 2. Expanding the arbitrator to, for example, 64, 128 or 256 queues would require 3, 4, or 5 levels to determine a next queue.

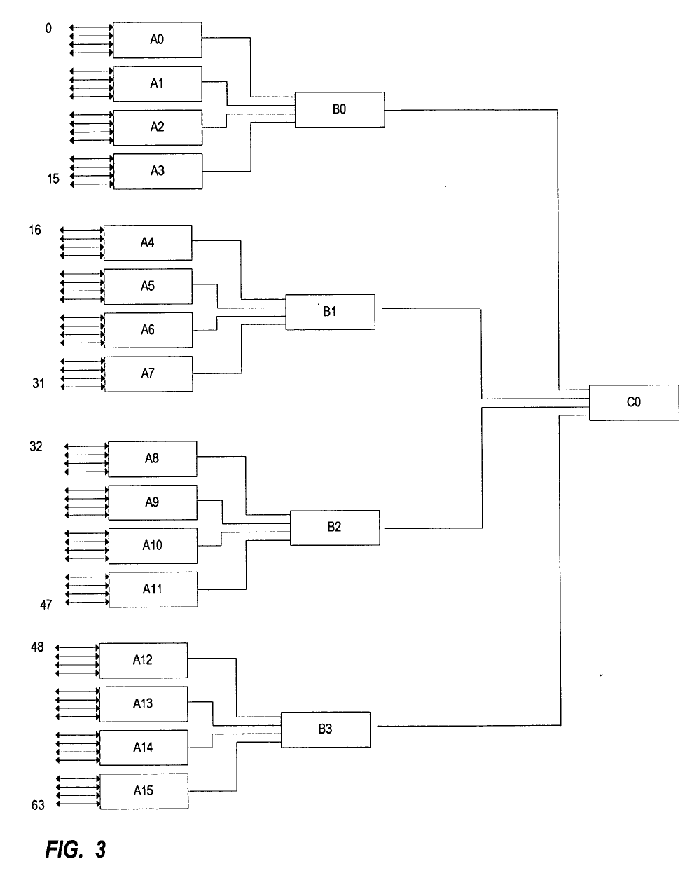

FIG. 3 illustrates an example arbitrator for 64 queues. The arbitrator includes sixteen 4×1 arbiters (A0-A15) at level 0 arbitrating amongst the queues (Q0-Q63), four 4×1 arbiters (B0-B3) at level 1 arbitrating amongst the level 0 arbiters, and one 4×1 arbiter (CO) at level 2 arbitrating amongst the level 1 arbiters. It should be noted that the level 0 arbiters are not illustrated with the input control signals for ease of illustration and that the input control signals may be included to ensure that all the arbiters are reset at the same time once all the requests for the arbitration cycle are processed.

By way of a simple example assume that queues 2, 15, 31, 37, 40, 48 and 63 were ready for processing and that all the arbiters arbitrated on a RR basis. The arbiters associated with those queues (A0, A3, A7, A9, A10, A12 and A15) would have interrupts set as would the upstream arbiters that received these interrupts (A0 and A3 would cause B0 to be set, A7 would cause B1 to be set, A9 and A10 would cause B2 to be set, A10 and A12 would cause B3 to be set, and B0-B3 would cause C0 to be set).

During a first arbitration cycle (T0) C0 would select B0, B0 would select A0, and A0 would select Q2 (A0 arbiter complete—processed all of its requests). During T1, C0 would select B1, B1 would select A7, and A7 would select Q31 (A7 and B1 complete). During T2, C0 would select B2, B2 would select A9, and A9 would select Q37 (A9 complete). During T3, C0 would select B4, B4 would select A12, and A12 would select Q48 (A12 complete). During T4, C0 would select B0, B0 would select A3, and A3 would select Q15 (both A3 and B0 complete). During T5, C0 would select B2, B2 would select A10, A10 would select Q40 (both A10 and B2 complete). During T6, C0 would select B2, B2 would select A15, and A15 would select Q63 (A15, B3, and C0 complete—all queues processed). That is, the queues were processed in the following order Q2, Q31, Q37, Q48, Q15, Q40, and Q63.

As previously discussed we can use more complicated arbitration schemes to give certain queues or groups of queues higher priority. In addition to using more complicated arbitration schemes the hierarchical scheme can be expanded to cover multiple priority levels, where different priority queues are processed by different levels of the hierarchy. For example, the lower the priority the further down in the hierarchy the queues are arbitrated. The arbitration from lower priority queues may be arbitrated along with higher priority queues. The number of levels required for each priority may be based on the number of queues and the type of arbiters. For example, if the 64 queues of FIG. 3 were divided into 32 high priority queues and 32 low priority queues, the queues could be processed at different levels of the hierarchy. Assuming 4×1 arbiters were used, we would need three levels to handle each priority. The highest level of arbitration for the low priority queues may be processed together with the lowest level (e.g., queues) of the high priority queues.

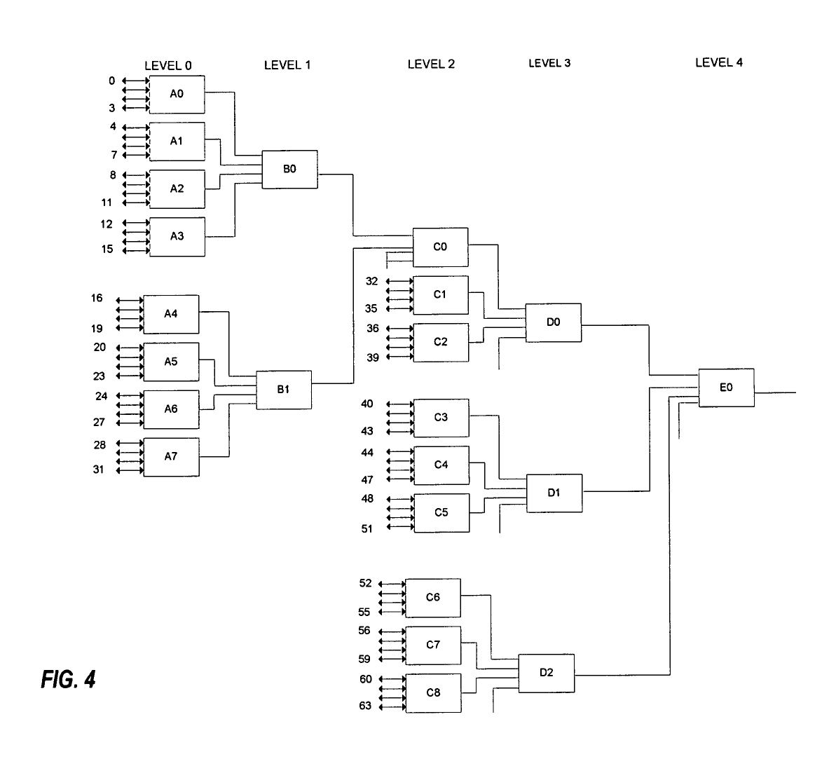

FIG. 4 illustrates an example hierarchical arbitrator having different priority queues handled at different levels of the hierarchy. As illustrated, there are 64 queues (labeled 0-63) total with 32 of the queues being low priority queues (labeled 0-31) and 32 being high priority queues (labeled 32-63). The low priority queues are handled by the three lowest levels of the hierarchy (levels 0-2) and the high priority queues are handled by the three highest levels of the hierarchy (levels 2-4), with the middle level (level 2) of the hierarchy arbitrating between high level queues (arbiters C1-C8) and the arbitration results of the lower level arbiters (arbiter C0). The lowest level for each priority (e.g., level 0 for low priority, level 2 for high priority) handles the input queues (.

Level 0 includes eight 4×1 arbiters (labeled A0-A7) to arbitrate amongst the low priority queues. Level 1 includes two 4×1 arbiters (B0-B1) to arbitrate between the level 0 arbiters. Level 2 has eight 4×1 arbiters (C1-C8) to arbitrate amongst the high priority queues and a ninth arbiter (C0) to arbitrate amongst the level 1 arbiters. Level 3 has three 4×1 arbiters (D0-D2) that each arbitrate between three level 2 arbiters. Level 4 includes a 4×1 arbiter (E0) that arbitrates amongst the three level 3 arbiters.

Using the same quick example discussed above with respect to FIG. 3, assume that queues 2, 15, 31, 37, 40, 48 and 63 were ready for processing. Accordingly, the arbiters associated with those queues (A0, A3, A7, C2, C3, C5 and C8) would have interrupts set as would the upstream arbiters that received these interrupts (A0 and A3 would cause B0 to be set, A7 would cause B1 to be set, B0 and B1 would cause C0 to be set, C0 and C2 would cause D0 to be set, C3 and C5 would cause D1 to be set, C8 would cause D2 to be set and D0-D2 would cause E0 to be set).

Assuming the arbiters were simple RR arbiters, during a first arbitration cycle (T0) E0 would select D0, D0 would select C0, C0 would select B0, B0 would select A0, and A0 would select Q2 (A0 arbiter complete—processed all of its requests). During T1, E0 would select D1, D1 would select C3, and C3 would select Q40 (C3 complete). During T2, E0 would select D2, D2 would select C8, and C8 would select Q63 (both D2 and C8 are complete). During T3, E0 would select D0, D0 would select C2, and C2 would select Q37 (C2 complete). During T4, E0 would select D1, D1 would select C5, and C5 would select Q48 (both C5 and D1 complete). During T5, E0 would select D0, D0 would select C0, C0 would select B1, B1 would select A7, and A7 would select Q31 (both A7 and B1 complete). During T6, E0 would select D0 again, D0 would select C0 again, C0 would select B0, B0 would select A3, and A3 would select Q15 (A0, B0, C0, D0 and E0 complete—all queues processed). That is, the queues were processed in the following order Q2, Q40, Q63, Q37, Q48, Q31, and Q15.

Comparing the results of the example queue interrupt scenario from FIGS. 3 and 4, shows that the low priority queues (Q31 and Q15) were moved down in the processing chain (took more arbitration cycles to be selected for processing) for the multi-level priority arbitrator of FIG. 4.

The arbiters in the multi-level arbitrator may utilize more complex arbitration schemes (e.g., WRR, DRR). These schemes enable quantums to be assigned to specific queues or specific sets of queues so that these queues or groups of queues get extra processing. As discussed above, the arbiters may be capable of running RR arbitration or a more complex arbitration scheme based on which mode the arbiter is set for (e.g., set complex bit if complex arbitration scheme is to be used). The arbiters having the complex arbitration scheme activated would utilize the quantums and deficit counters for quality of service (QoS) provisioning. According to one embodiment, the arbiters receiving requests directly from the queues (e.g., level 0, level 2) have the complex arbitration set while the arbiters receiving requests from other arbiters (e.g., level 1, level 3, level 4) do not.

The arbitrators discussed with respect to FIGS. 2-4 enable the QM to perform arbitration so that the core processor need not to spend processing time arbitrating amongst queues. However, if multiple queues need processing (dequeuing) the QM may issue multiple interrupts (requests for processing). The core processor may spend a significant amount of time processing the interrupts (running interrupt service routines). In an extreme case, the core processor may not have enough cycle time to perform useful processing (“livelock”). One possible solution is to limit the rate the NPEs are filing up the queues/FIFOs in the QM until the core processor has finished processing its high priority tasks (e.g. voice/DSP tasks). However, limiting the operation of the network processor is not a preferable option.

According to one embodiment, the core processor may control the number of interrupts that it receives from the QM by allotting a certain number of flow control credits to the QM. The flow control credits are decremented whenever a grant is given to one of the queues. When there are no more flow control credits (e.g., the core processor has granted the allotted number of grants) the QM will not send anymore interrupts until the core processor resets the flow control credits. When the core processor is busy it will not replenish the flow control credits so the QM will be limited to interrupting the core processor the allotted number of times during busy periods. The core processor may reset the flow control credits once it is finished performing required or higher priority functions (is running a low priority task or background task). The core processor may continue to replenish the flow control credits while the core processor is not performing required/higher priority functions.

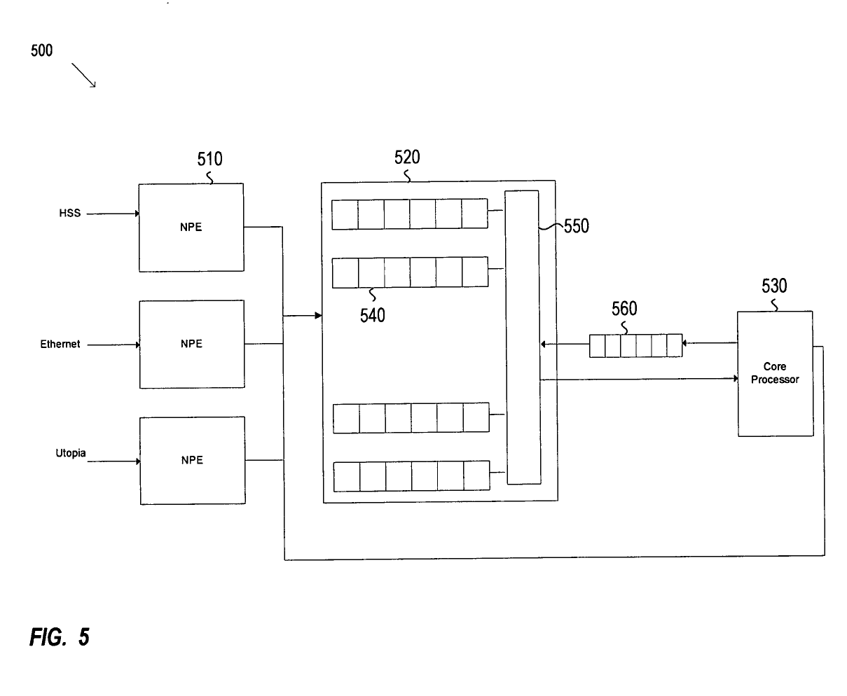

FIG. 5 illustrates an example network processor 500 that includes a plurality of NPEs 510, a QM 520 and a core processor 530. The QM includes FIFOs 540 for tracking amount of data in each queue and associated location and an arbitrator 550 (e.g., FIGS. 2-4) for arbitrating amongst the queues. The core processor 530 issues the QM 520 flow control credits 560 that the QM 520 uses to issue interrupts (requests) and receive grants from the core processor 530. The QM 520 will only forward interrupts if there are credits 560 remaining. As noted above the credits 560 are replenished during non-priority processing by the core processor 530.

The use of the flow control credits may alleviate the livelock problem that occurs in the core processor when it is processing numerous interrupts and cannot perform other required/high-priority processing. However, some queues may be have quality of service standards (e.g., voice data) that may not be able to wait for additional credits to be allocated if the credits are currently used. These queues may be defined as pre-emptive queues that can forward interrupts to the core processor when the arbitrator determines even if no credits are available. The priority arbiter may always grant to the high priority pre-emptive queues when it has at least one input queues requesting, and an interrupt will be asserted to the core processor.

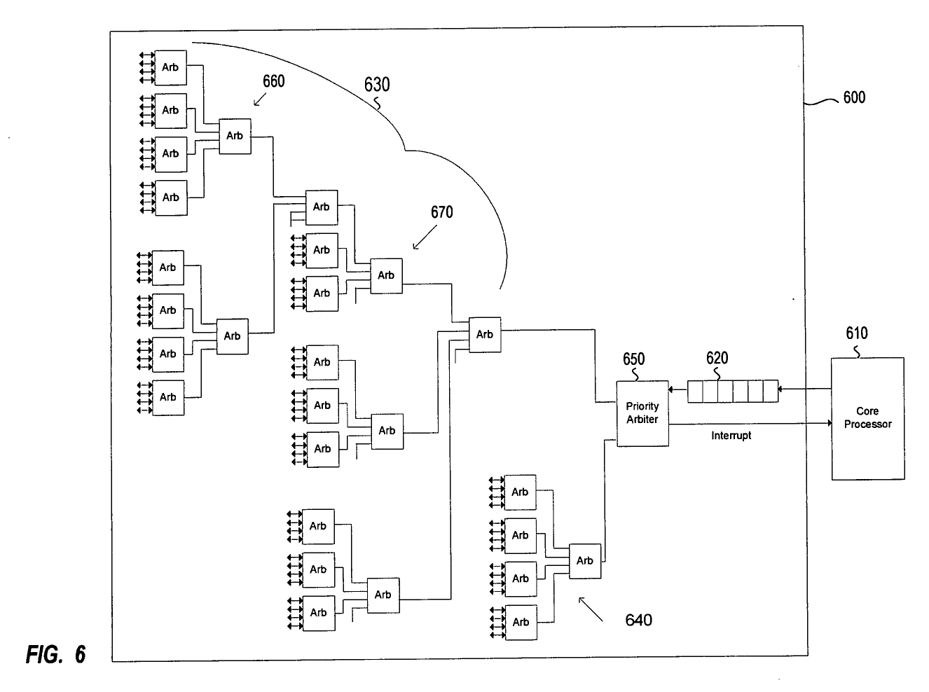

FIG. 6 illustrates an example QM 600 communicating with a core processor 610. The core processor 610 issues flow control credits 620 to the QM 600 to control the number of interrupts that the QM 610 issues to the core processor 610 during priority processing of the core processor 610. The QM 600 may include a multi-level multi-priority arbitrator. The queues tracked by the multi-level multi-priority arbitrator may include regulated queues 630 that will not have interrupts (requests) issued unless there are flow control credits 620 available and pre-emptive queues 640 that will have interrupts issued whether or not there are flow control credits 620 available. A priority arbiter 650 may be used to give the preemptive queues 640 priority. The regulated queues 630 may be divided into lower priority queues 660 and higher priority queues 670 with the lower priority queues 660 being located at lower levels of the hierarchy and the higher priority queues being located at higher levels of the hierarchy.

The QM 600 can be used in network processor applications such as a converged access point (CAP) where audio, video, voice and data streams are received and processed. Voice, video and audio streams are different than pure data streams because they are critically sensitive to network delays and to variations in available network bandwidth. Random network delays and unmanaged variations in bandwidth render these media streams, and thus services, useless for the end user which would deter customers from deployment of such functions. Accordingly, the QM 600 can provision the voice streams into the high-priority pre-emptive queues 640, video and audio streams as high priority QoS data into high-priority regulated queues 670, and low-priority QoS data into the low-priority regulated queues 660.

The QM arbitrators discussed above provide network processors with a proper and efficient solution to manage time/bandwidth dependencies of sensitive streams by insuring the stream is allocated sufficient bandwidth for proper service delivery with minimal delay in processing. In addition the QM arbitrators enable explicit control over the core processor bandwidth allocated to each video/audio and voice source in the network processors.

The arbitrators of FIGS. 2-4 and 6 utilized 4×1 arbiters, however the various embodiments are clearly not limited thereby. Rather, the arbiters can be M×1 arbiters were M is the number of request inputs an arbiter receives. For example, an arbitrator using 2×1 arbiters would require 6 levels to arbitrate among 64 queues while an arbitrator using 8×1 arbiters would only require 2 levels. The number of levels can be determined the number of queues and the number of inputs each arbiter handles. While using the same type of arbiters for the arbitrator provides for easier development of the arbitrator, each of the arbiters need not have the same value M. For example, the 16 queues of FIG. 2 may have an arbitrator that includes eight 2×1 arbiters in a first level, two 4×1 arbiters on a second level, and one 4×1 arbiter on a third level.

Although the various embodiments have been illustrated by reference to specific embodiments, it will be apparent that various changes and modifications may be made. Reference to “one embodiment” or “an embodiment” means that a particular feature, structure, or characteristic described in connection with the embodiment is included in at least one embodiment. Thus, the appearances of the phrase “in one embodiment” or “in an embodiment” appearing in various places throughout the specification are not necessarily all referring to the same embodiment.

Different implementations may feature different combinations of hardware, firmware, and/or software. In one example, machine-readable instructions can be provided to a machine (e.g., an ASIC, special function controller or processor, FPGA or other hardware device) from a form of machine-accessible medium. A machine-accessible medium may represent any mechanism that provides (i.e., stores and/or transmits) information in a form readable and/or accessible to the machine. For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like.

The various embodiments are intended to be protected broadly within the spirit and scope of the appended claims.

What is claimed is:

1. An apparatus comprising
a plurality of registers associated with a plurality of queues storing data awaiting processing, wherein the registers track amount and location of data for the associated queues and generate a request for dequeuing the data when the associated queue has a certain amount of data associated therewith; and
an arbitrator to arbitrate among the requests and to forward an arbitrated request for processing.

2. The apparatus of claim 1, wherein said arbitrator includes a plurality of arbiters, wherein the arbiters are arranged in at least two levels, wherein the arbiters in a first level receive requests from the registers, and wherein the arbiters in a second level receive requests from the first level arbiters.

3. The apparatus of claim 2, wherein the first level arbiters include input control signals to synchronize reset of said arbitrator.

4. The apparatus of claim 3, wherein the input control signals from the first level arbiters are provided to a logical AND gate to synchronize reset of the first level arbiters.

5. The apparatus of claim 3, wherein an input control signal for a first level arbiter is activated when the first level arbiter has no requests for processing.

6. The apparatus of claim 5, wherein each of the first level arbiters includes a logical AND gate to AND the input control signals from other first level arbiters, wherein the first level arbiters are reset if output of the logical AND is activated.

7. The apparatus of claim 2, wherein the arbiters utilize a round robin arbitration scheme.

8. The apparatus of claim 2, wherein the arbiters utilize a complex arbitration scheme that includes different weights for different inputs.

9. The apparatus of claim 2, wherein type of arbitration used by the arbiters can be set.

10. The apparatus of claim 1, wherein said arbitrator includes at least two priority levels, wherein a lower priority level arbitrates among requests from lower priority queues and a higher priority level arbitrates among requests from higher priority queues and the lower priority level.

11. The apparatus of claim 1, wherein said arbitrator receives flow control credits and only forwards requests if credits are available.

12. The apparatus of claim 11, wherein said arbitrator includes a preemptive portion, wherein requests from the preemptive portion are forwarded even if no credits are available.

13. A network processor comprising
at least one receiver to receive data from external sources, wherein the data is stored in queues while the data awaits processing, wherein the data is assigned to a specific queue based on parameters associated with the data;
a queue manager to track status of queues and to arbitrate among requests for processing the queues, wherein said queue manager includes a plurality of arbiters arranged in at least two levels, wherein the arbiters in a first level receive requests from the queues and the arbiters in a second level receive requests from the first level arbiters, and wherein the first level arbiters include input control signals to synchronize reset thereof.

14. The network processor of claim 13, further comprising a core processor to perform multiple operations including dequeuing the data stored in the queues based on requests from said queue manager.

15. The network processor of claim 13, wherein the input control signals are activated when an associated first level arbiter has no requests left to process, wherein the input control signals are provided to a logical AND gate, and wherein the first level arbiters are reset if output of the logical AND gate is activated.

16. The network processor of claim 13, wherein the arbiters are capable of utilizing simple or complex arbitration schemes based on an arbitration setting.

17. The network processor of claim 16, wherein different levels of said queue manager use different arbitration schemes.

18. The network processor of claim 13, wherein said queue manager includes at least two priority levels of arbitration, wherein a lower priority level arbitrates among requests from lower priority queues and a higher priority level arbitrates among requests from higher priority queues and the lower priority level.

19. The network processor of claim 13, wherein said queue manager receives flow control credits and only forwards requests if credits are available.

20. The network processor of claim 13, wherein said queue manager includes a preemptive portion, wherein requests from the preemptive portion are forwarded even if no credits are available.

21. A system comprising
a network processor including
at least one receiver to receive data from external sources, wherein the data is stored in queues while the data awaits processing, wherein the data is assigned to a specific queue based on parameters associated with the data;
a queue manager to track status of queues and to arbitrate among requests for processing the queues, wherein said queue manager includes an arbitration hierarchy having arbiters arranged in at least two levels, wherein the arbiters in a first level receive requests from the queues and the arbiters in a second level receive requests from the first level arbiters, and wherein the first level arbiters include input control signals to synchronize reset thereof; and
dynamic random access memory to store data in the queues responsive to said network processor.

22. The system of claim 21, wherein the input control signals are activated when an associated first level arbiter has no requests left to process, wherein the input control signals are provided to a logical AND gate, and wherein the first level arbiters are reset if output of the logical AND gate is activated.

23. The system of claim 21, wherein the arbitration hierarchy includes at least two priority levels, wherein a lower priority level arbitrates among requests from lower priority queues and a higher priority level arbitrates among requests from higher priority queues and the lower priority level.

24. The system of claim 21, wherein the arbitration hierarchy receives flow control credits and only forwards requests if credits are available.

25. The system of claim 21, wherein said arbitrator includes a preemptive portion, wherein requests from the preemptive portion are forwarded even if no credits are available.
